(19) United States
(12) Patent Application Publication
(10) Pub. No.: US 2004/0185079 A1
(43) Pub. Date: Sep. 23, 2004

(54) Floating sustained release pesticide granules

(76) Inventor: Eliezer Zomer, Newton, MA (US)

Correspondence Address: PERKINS, SMITH & COHEN LLP, ONE BEACON STREET, 30TH FLOOR, BOSTON, MA, 02108, US

(21) Appl. No.: 10/476,366

(22) PCT Filed: Apr. 15, 2002
(86) PCT No.: PCT/IL02/00302

(30) Foreign Application Priority Data
May 2, 2001 (IL) 142931

(51) Int. Cl. A01N 25/00

(52) U.S. Cl. 424/405; 514/12

(57) ABSTRACT

A floating sustained release pesticide granule adapted for broadcast application for controlling a population of insects in an aquatic environment, comprising an effective amount of an active ingredient suspended in a water soluble sunscreen agent, and a floatation agent, said active ingredient, sunscreen agent and floatation agent embedded in an insoluble fibrous matrix such that when said granule is in contact with water, said water soluble sunscreen agent dissolves over time thereby releasing the active ingredient into the water in a sustained release manner. The invention additionally relates to a method for the production of said granule and to a method for controlling an insect population at the using said granule.

### FIELD OF THE INVENTION

The present invention relates to the field of pesticides. More specifically, the present invention relates to a novel floating sustained release pesticide granule adapted for broadcast application in an aquatic environment. The present invention also relates to a method for the production of said granule and to a method for controlling an insect population at the larval stage using said granule.

### BACKGROUND OF THE INVENTION

In the present disclosure, the term “pesticide” is meant to include ovicides, larvicides, pupicides, insecticides, biological agents, pathogens, parasites, microbial control agents, insect growth regulators, conventional toxicants, pesticides, or other agent used to control a population of insects.

Chemical pesticides are conventionally used for controlling various insect populations that carry diseases that are harmful or deadly to humans and animals. Over time, unfortunately, resistance is often developed against the pesticide and the pesticide does more long-term environmental damage than it did short term good. It is for this reason that in recent years, scientists have tried to formulate pesticides that utilize biological, naturally occurring active ingredients. Increased attention has been given to biological control agents or “natural enemies” such as predators, parasites, and pathogens. Such pesticides would assure little or no toxicity to the environment while providing high toxicity to the target species, and less likelihood of the development of biological resistance. However, it has proven to be extremely difficult to develop such a pesticide that can be delivered in an effective and inexpensive manner.

The requirements for a pesticide composition include: high specific toxicity to target organisms, safe towards non-target organisms, ability to be mass produced relatively inexpensively on an industrial scale, long shelf life, ability to be applied using conventional equipment, and transportability. For aerial application, the pesticide must be adaptable for even application even in wind or turbulence and it must be able to penetrate into vegetation canopies. It is also desirable that the immature aquatic stages of mosquito species be controlled before reaching the adult phase, when they are become capable of being a nuisance and transmitting disease. Controlling insects at the immature aquatic stage is safer to the environment, because only the breeding sites need to be targeted. Aside from various mosquito species, other insects whose population needs to be controlled include biting and nonbiting midges, black flies, moth flies, crane flies, horse flies, and deer flies.

Bacillus thuringiensis (Bt), fulfills the requisites of an “ideal” biological control agent better than all other bio-control agents found to-date, thus leading to its widespread commercial development. Bt is a gram-positive, aerobic, endospore-forming saprophyte bacterium, naturally occurring in various soil and aquatic habitats. Bt subspecies are recognized by their ability to produce large quantities of insect larvicidal proteins (known as _-endotoxins) aggregated in parasporal bodies. Hydrophobic bonds and disulfide bridges tightly pack these insecticidal proteins, synthesized during sporulation. The transition to an insoluble state presumably makes the _-endotoxins protease-resistant and allows them to accumulate inside the cell. The high potencies and specificities of Bt's insecticidal crystal proteins (ICPs) have spurred their use as natural pest control agents in agriculture, forestry and human health. The genes coding for the ICPs, that are normally associated with large plasmids, direct the synthesis of a family of related proteins that have been classified as cryI-VI and cytA classes (the old nomenclature) depending on the host specificity (lepidoptera, diptera, coleoptera and nematodes) and the degree of amino acid homology. The current classification (cryl-22 and cytl-2 group genes) is uniquely defined by the latter criterion.

Bti has been established as a commercially viable and promising alternative to conventional mosquito larvicides, particularly in sensitive ecological situations. In suitable formulations, it is a useful supplement to, or replacement for broad-spectrum chemicals. The development of effective formulations requires that the feeding behavior of the different target species be taken into account. Several commercial formulations are available for large application: liquid concentrates, wettable powders, granules, and ice granules. All, however, exhibit only short-term stability in the field and require frequent application.

A pest control agent in the form of granules is preferred in aerial applications. Such dense granules permit accurate application of the pest control agent in high winds. The granules permit penetration of dense vegetation canopies and reduce uneven application (drift) caused by variations in winds and turbulence. During the breeding season, granules can be used to regulate the rate of pesticide release in an environmental body of water over an extended period of time. Granules consisting of 3-5 mm particles of released. However, such commercially available formulations are only effective for up to 24-48 hours, and require frequent applications to achieve effective control.

The prior art is replete with pesticidal compositions. U.S. Pat. No. 5,019,564 and U.S. Pat. No. 5,770,138 described insecticidal granules containing waste pulp or paper sludge. The granules have been used to deliver chemical mosquito larvicides and fertilizers by post-production adsorption and drying. The load, however, was too low to enable effective delivery of the larvicides or fertilizers.

Other patents describe biodegradable polymers such as alginate, carageenan or proteins for the delivery of fungicide for soil pathogens, mycological herbicides, or biological insecticides. These include U.S. Pat. No. 4,724,147, U.S. Pat. No. 4,668,512, U.S. Pat. No. 4,718,935, U.S. Pat. No. 5,074,902, and U.S. Pat. No. 4,971,796. U.S. Pat. No. 4,434,231 describes the entrapment of microorganisms in biomaterials for nitrogen fixation. A wax or cork core coated with a water adhesive matrix for floatation is disclosed in U.S. Pat. No. 5,283,060, and U.S. Pat. No. 5,484,600. While the formulations are able to float, all active ingredients are released within 2-3 days. Sand and toxin entrapped in water-soluble matrix is the subject of other patents (U.S. Pat. No. 5,484,600, U.S. Pat. No. 5,567,430, U.S. Pat. No. 4,631,857). All these patents either have a too short delivery time or are not economical for manufacturing. Other related patents include: U.S. Pat. No. 5,019,564 and U.S. Pat. No. 5,770,138 describe methods of making enhanced non-clay granules made from pulp or paper sludge. U.S. Pat. No. 5,484,600 describes pesticide formulated into a quick release granule or a slow release granule. The slow release formula necessitates water soluble adhesives which are cross-linked with aldehydes, and is thus unsuited for use in drinking water reservoirs. U.S. Pat. No. 5,529,772 discloses a granule coats with lignin. Crecchio et al. [Soil Biol. Biochem (1998), 30 (4), 463-470)] discloses a toxin produced by a transgenic plant that was engineered to produce active or soluble toxin, for application into the soil. U.S. Pat. No. 4,718,935 is a method for the preparation of mycoherbicide-containing pellets. U.S. Pat. No. 5,074,902 discloses a granular products containing fungi encapsulated in a wheat gluten matrix for biological control of weeds. U.S. Pat. No. 4,724,147 is a preparation of pellets containing fungi for control of soil-borne diseases. U.S. Pat. No. 4,668,512 is a preparation of pellets containing fungi and nutrient for control of soil-borned plant pathogen. U.S. Pat. No. 4,971,796 is a slow release pest control granule composition. U.S. Pat. No. 4,434,231 is a means for embedding microorganisms in a polymer matrix. U.S. Pat. No. 5,283,060 discloses a bacillus-containing mosquito's larvicide granules. U.S. Pat. No. 5,484,600 discloses an insecticidal composite timed released particle. U.S. Pat. No. 4,985,251 discloses flowable insecticidal delivery compositions and methods for controlling insect populations in an aquatic environment. U.S. Pat. No. 4,818,534 discloses insecticidal delivery compositions and methods for controlling a population of insects in an aquatic environment U.S. Pat. No. 4,650,792 discusses Mosquito abatement. U.S. Pat. No. 4,631,857 discloses a floating article for improved control of aquatic insects. U.S. Pat. No. 4,229,614 discloses a floating mosquito's larvicide dispenser. U.S. Pat. No. 4,218,5843 discloses a container for releasing dry chemical in a body of water. U.S. Pat. No. 5,824,328 discloses insecticidal delivery compositions and methods for controlling a population of insects in an aquatic environment. U.S. Pat. No. 5,567,430 discloses Insecticidal delivery compositions and a method for controlling a population of insects in an aquatic environment. U.S. Pat. No. 5,277,906 is an insecticidal composition of bacillus thuringiensis serovar israelensis, DSM 3435 and DSM 3440. U.S. Pat. No. 4,996,156 is a preparation of spore-free, concentrated protein preparations from bacillus thuringiensis serovar, israelensis, which is toxic for gnats, a microorganism for by a transgenic plant that was engineered to produce active or soluble toxin, for application into the soil. U.S. Pat. No. 4,718,935 discloses a method for the preparation of mycoherbicide-containing pellets. U.S. Pat. No. 5,074,902 discloses a granular products containing fungi encapsulated in a wheat gluten matrix for biological control of weeds. U.S. Pat. No. 4,724,147 discloses a method for preparation of pellets containing fungi for control of soil-borne diseases. U.S. Pat. No. 4,668,512 discloses a method for preparation of pellets containing fungi and nutrient for control of soil-borned plant pathogen. U.S. Pat. No. 4,971,796 discloses a slow release pest control granule composition. U.S. Pat. No. 4,434,231 discloses a means for embedding microorganisms in a polymer matrix. U.S. Pat. No. 5,283,060 discloses a bacillus-containing mosquito's larvicide granules. U.S. Pat. No. 5,484,600 discloses an insecticidal composite timed released particle. U.S. Pat. No. 4,985,251 discloses flowable insecticidal delivery compositions and methods for controlling insect populations in an aquatic environment. U.S. Pat. No. 4,818,534 discloses insecticidal delivery compositions and methods for controlling a population of insects in an aquatic environment. U.S. Pat. No. 4,650,792 discusses Mosquito abatement. U.S. Pat. No. 4,631,857 discloses a floating article for improved control of aquatic insects. U.S. Pat. No. 4,228,614 discloses a floating mosquito's larvicide dispenser. U.S. Pat. No. 4,218,843 discloses a container for releasing dry chemical in a body of water. U.S. Pat. No. 5,824,328 discloses insecticidal delivery compositions and methods for controlling a population of insects in an aquatic environment. U.S. Pat. No. 5,567,430 discloses Insecticidal delivery compositions and a method for controlling a population of insects in an aquatic environment. U.S. Pat. No. 5,277,906 discloses an insecticidal composition of bacillus thuringiensis serovar israelensis, DSM 3435 and DSM 3440. U.S. Pat. No. 4,996,156 discloses a preparation of spore-free, concentrated protein preparations from bacillus thuringiensis serovar, israelensis, which is toxic for gnats, a microorganism for their preparation, and the isolation of the microorganism H875 Toxin-encoding nucleic acid fragments derived from a Bacillus thuringiensis subsp. israelensis gene. U.S. Pat. No. 4,945,057 discloses monoclonal antibodies to crystal protein of Bacillus thuringiensis subspecies israelensis U.S. Pat. No. 4,609,550 discloses Bacillus cereus subspecies israelensis. U.S. Pat. No. 4,978,623 discloses methods and compositions for expression of BTI endotoxin. U.S. Pat. No. 4,652,628 discloses methods and compositions for expression of BTI endotoxin.

It is to be understood that all of the patents mentioned above are meant to be incorporated by reference in their entireties.

Accordingly, it is the primary aim of the present invention to provide a novel floating granule adapted for releasing at least one active pesticide ingredient in an aquatic environment in a timed-release manner. The granule of the present invention is active for an extended period of time, thereby reducing the number of applications required. Since it utilizes a biologically-occurring active ingredient, it is nontoxic to the environment while being effective in killing the target population(s). These and other features of the present invention will be further understood and appreciated from the summary of the invention and the detailed description that follow.

### SUMMARY OF THE INVENTION

The present invention relates to a floating sustained release pesticide granular composition that is adapted to be dispersed by land or aerial application into a substantially aquatic environment where insects breed. The composition comprises: an effective amount of an active pesticide ingredient suspended in a water soluble sunscreen agent, and a floatation agent. The active ingredient, the sunscreen agent and the floatation agent, and a floatation agent. The active ingredient, the sunscreen agent and the floatation agent are embedded in an insoluble fibrous matrix. When the granule contact water, the sunscreen agent slowly dissolves, thereby releasing the active pesticide ingredient into the water. The granule is formulated to be hydrophobic and to float on water. The breakdown products of the granule are non-toxic being suitable for human consumption. The active ingredient of the granule is released in a sustained manner for a period of approximately three weeks to 30 days.

The rate of release of the active ingredient is determined by the dissolution rate of the granule's content in water. Therefore, the granule may be formulated with different percentages of insoluble fibrous matrix sunscreen agent, and floatation agent to render the desired time-releasing properties and floatation properties according to the larvae population(s) that are being targeted. To target a plurality of different mosquito species, breeding at different water levels, it may be suitable to prepare a composition having granules of a range of sizes. For example, larvae of mosquito species Aedes and black flies feed near the bottom of the water. Thus, granules with sorter floating durations are most appropriate for these species. Granules with longer longing durations are optimal for controlling mosquito larvae of the species Anopheles, which feed near the water surface. Mosquito larvae of the species Culex feed at various water depths. In most embodiments, the granule is adapted to release active ingredient for up to 30 days. The granule is stable for at least 2 to 4 weeks in the field and, once ingested by mosquito larvae, causes death within 24 hours (in other pests, death may take longer).

Preferably, the active ingredient comprises a larvicidal protein. More preferably, the larvicidal protein comprises the delta endotoxin of Bacillus thuringiensis israelensis (Bti). It is appreciated that other appropriate biologically occurring larvicidal proteins may be used as well for example, Bacillus sphericus. Preferable, the amount of active ingredient is between 5-60 wt %.

may be used as well for example, Bacillus sphericus. Preferable, the amount of active ingredient is between 5-60 wt %.

The floatation agent is preferably selected from perlite or vermiculite or from industrial by-products such as feather particles, or peanut shell particles and other cellulose byproducts. These floating agent or agents are treated with a hydrophobic material such as molten wax (paraffin) or hydrophobic silica to effect time-controlled wetting of the granule, required for the sustained release of the active ingredient in the breeding habitat (natural oils or fats can also be used as a hydrophobic material). The concentration of the floatation agent in the pesticide granule is preferably 5-60 wt %.

Preferably, the water soluble sunscreen agent used as a suspending matrix for the Bti protein comprises a naturally occurring pigment such as water-soluble humate, a natural deposit of plant polyphenols. The humate has low water solubility and a very high sunlight adsorption, thereby providing for the sustained release of the Bti protein while also protecting the protein from possible damages of sunlight. Preferably, the humate is at a concentration of 1-25 wt %.

The insoluble fibrous matrix is preferably sludge having cellulose fibers or any fibrous cellulitic matrix produced as a by-product from an industrial process. Pulp and paper manufacturing operations produce a substantial flow of waste water. The solid material which is filtered out of the waste water, called “sludge,” is expensive to dispose of because it must be either burned or buried in landfill operations. The present application provides for one effective way to utilize sludge. In some embodiments, the sludge is treated with hydrophobic material.

According to preferred embodiments of the present invention, the composition further comprises a surfactant. Preferably, the surfactant is selected from a biodegradable anionic or neutral surface-active agent to enhance the solubilization of the Bti protein. Thus, the presence and quantity of surfactant also influences the dissolution and rate of release of the Bti toxic protein. In some preferred embodiments, the surface-active agent is alkyl polyglucoside or alkyl aryl sulfonate preferably at a concentration of 0.001-0.5 wt % and more preferably at a concentration of 0.005-0.1 wt %.

Further according to preferred embodiments of the present invention, the granule further comprises an inert filling material such as a calcium carbonate or a silicate. Preferably, the filling material is at a concentration of 1-25 wt %.

Additionally according to preferred embodiments of the present invention, the granule further comprises a feeding stimulant. In some embodiments, the feeding stimulant is selected from fish meal, soy meal, cotton seed meal, yeast meal and extracts. Preferably, the feeding stimulant is at a concentration of 0.1-10.0 wt %.

The present invention also relates to a method for controlling a population of insects comprising applying by broadcast means a sustained release pesticide granular composition comprising 5-60% of a larvicidal protein, 5-60% floating hollow particles coated with hydrophobic material, 1-25% water soluble sunscreen pigment, and 1-25% of insoluble fibrous matrix.

According to preferred embodiments of the present invention, the granular composition further comprises 1-25% of inert filling material. Preferably, the inert filling material is selected from the group consisting of calcium carbonate or silicates.

Further according to preferred embodiments of the present invention, the granular composition further comprises 0.1-10% larvae feeding stimulants. In some preferred embodiments, the larvae feeding stimulants are selected from the group consisting of fish meal, soy meal, cotton seed meal, and yeast meal.

Additionally according to preferred embodiments of the present invention, the granular composition further comprises 0.1-5% of natural detergents. The natural detergent is preferably selected from the group consisting of alkyl polysaccharides or Tweens.

Moreover according to preferred embodiments of the present invention, the larvicidal protein comprises the delta endotoxin of Bacillus thuringiensis israelensis.

Further according to preferred embodiments of the present invention, the water soluble sunscreen pigment comprises humate.

Additionally according to preferred embodiments of the present invention, the floating hollow particles are selected from the group consisting of: perlites, vermiculites, feather powder, peanut shells, corn cob, and cork byproducts.

Moreover according to preferred embodiments of the present invention, the hydrophobic material comprises molten wax or hydrophobic silica or any natural oil or fat.

Additionally according to preferred embodiments of the present invention, the insoluble fibrous matrix is derived from sludge.

The present invention also relates to a method for producing a sustained release pesticide granule comprising;

(One) mixing an active pesticide ingredient with a water soluble sunscreen agent to create a slurry;

(Two) adding a predetermined amount of floating hollow particle coated with a hydrophobic material to said slurry and mixing until a substantially homogenous mixture is formed;

(Three) blending pre-treated industrial sludge with said mixture until a wet granule composite appears;

(Four) rolling the resulting composite to achieve the desired range of granule sizes;

(Five) optionally, drying the granules until residual water amount reaches a desired level.

According to preferred embodiments of the present invention, the method further comprises adding at least one of the group consisting of: surfactants, inert filling materials, feeding stimulants, natural detergents, and buffers.

Further according to preferred embodiments of the present invention, the method also comprises applying further amounts of said hydrophobic material.

Additionally according to preferred embodiments of the present invention, the active ingredient is a larvicidal protein. Preferably, the larvicidal protein is the delta endotoxin of Bacillus thuringiensis israelensis.

Moreover according to preferred embodiments of the present invention, the water soluble sunscreen agent comprises humate.

Further according to preferred embodiments of the present invention, the floating hollow particles are selected from the group consisting of: perlites, vermiculites, feather powder, peanut shells, corn cob, and cellulose byproducts.

Additionally according to preferred embodiments of the present invention, the hydrophobic material comprises molten wax or hydrophobic silica or natural fats or oils derived from animals or vegetables.

### DETAILED DESCRIPTION OF THE INVENTION

It is appreciated that the detailed description of the invention provided is intended only to illustrate certain preferred embodiments of the present invention for the purposes of example and clarification only. It is in no way meant to limit the scope of the invention, as set out in the claims.

The following represents a manufacturing process for manufacturing 1000 kg of product:

Ingredients:

Bti powder produced by Becker Microbial Products (7000ITU/mg), Plantation Fla., USA or liquid produced by Zohar Dalia of Kibbutz Dalia, Israel.

Vermiculite/Perlite produced by The Schundler Company, Metuchen, N.J., USA.

Paper sludge from Neyar Hedera Paper Mill, Israel, containing greater than 35% cellulose content.

Wax Suspension produced by Michelman, Inc., Cincinnati, Ohio, USA (in nano-suspension).

Humic Acid soluble powder produced by Grow More, Gardena Calif., USA (greater than 95% water solubility).

Procedure:

In main mixing tank 1) Using feeder, combine 150 kg Bti powder with 100 kg humic acid mixture and place into stainless steel mixer (cement mixer, ribbon blender).

2) Blend at ambient temperature, for 10 to 20 minutes, until homogenous.

3) Add through sprayer melted 50 kg wax suspension.

4) Mix well for 10-20 minutes, until homogenous.

In second mixing tank:

5) Add 300 kg vermiculite.

6) Add through sprayer an additional melted 100 kg wax suspension (60 C).

7) Keep temperature above 60 C and mix well for 10-20 minutes, until homogenous.

8) Add batch-wise 300 kg (dry weight) wet paper sludge (50% slurry) preheated to 60° C. and adjust pH to 5.5 to 6.5 by adding Citric acid).

9) Mix well for 30 minutes until all fibers are well coated

10) Add mixture of tank 2 into tank 1

11) Mix well for 10-20 minutes, until homogeneous.

12) Transfer mixture to granulator, and produce 2-8 mm granules.

13) Dry granules at 95-105° F. using a rotary-dryer for 60 minutes or longer to evaporate all residual water to less than 10%. Measure moisture content using, for example, a Moisture Analyzer.

The granulation process should be set to generate at least 50% granules with a mesh size of 4-12 at least 50% floating granules.

Additives such as water and wetting/dispersing agents may be used. It has been found that surfactants are important and useful in control of the wetting rate. As a preferred surfactant, an alkyl polyglucoside or alkyl aryl sulfonate or mixtures thereof may be used. The amount of surfactant may vary with the desired wetting rate, and may be anywhere from 0.001 to 0.5 wt %. More preferably, the surfactant may vary from 0.005 to 0.1 wt % of the total composite.

The floatation agent used is approximately 50 to 5000 microns in size, preferably 500 to 2000 microns, and must have a specific floating characteristic The floating agent needs to sustain floatation (resist water absorption for at least 7 to 30 days). Appropriate floatation agents include vermiculite (Shnieder co.), perlite (Shnider Co), feather powder, or corncob particles (Anderson Co.), Paper sludge cellulose, all requiring pre-treatment with water repellents. Natural and synthetic waxes, such as polyethylene, bee and Carbo waxes as well as alkylation and alkyl sillicon are used to control of wetting rate.

Control of floating characteristics of the granule is determined by the ratio of wax with respect to the sludge and the vermiculite. The floating characteristics are also influenced by the ratio of the surface area to the specific weight of the granule. The rate of release of Bti from the granule is determined substantially by the concentration of Bti present, by the amount of humic acid used, the pore size and surface of the granule.

An important advantage of the finished composite product is reduction of application interval. Using currently available compositions, application of Bti is required at weekly or biweekly intervals in order to achieve satisfactory results. With the sustained release granule of the present invention, the application intervals are reduced to approximately once a month. Considering that 80-90% of current cost is attributed to machinery and labor, the granular composition of the present invention significantly reduces the cost required for controlling pest populations. The granular composition of the present invention provides greater than 90% mosquito control with improved application efficiency and reduced application costs. It is estimated that the granular composition of the present invention will provide 50% to 80% cost savings in mosquito control programs.

Three sets of experiments were performed in order to test the effectiveness and the stability of the granular composition of the present invention. In the experiments, three different compositions were tested. The compositions, #1, #2, and #3, were formulated as follows:

TABLE 1
Formulation of Granular Compositions

| | #1 | #2 | #3 (control) |
|---|---|---|---|
| BTI (% wt) | 15 | 15 | 0 |
| Humate (% wt) | 10 | 10 | 10 |
| Vermiculite (% wt) | 30 | 30 | 30 |
| Wax (% wt) | 15 | 0 | 15 |
| Paper sludge (% wt) | 25 | 40 | 40 |
| Other (% wt) | 5 | 5 | 5 |

### EXPERIMENT 1

Different size granules of the above compositions were placed in 5-IL beakers in 500 mls water containing 100 larvae of Aedes aegypti (Bti concentration 32 ng/ml). The mortality was checked after 24, 48, 72, and 96 hours. At each time interval, all of the larvae (dead and alive) was removed and replaced with new larvae. At the 72 and 96 hour replacements, 200 larvae were used. The results are shown in Table 2 below. After 4 days, the granules are still effective in killing a high percentage of larvae.

TABLE 2
Results of Experiment 1 - Formulation Screening

| Composition | Mesh size | 24 hrs | 48 hrs | 72 hrs | 96 hrs |
|---|---|---|---|---|---|
| #1 | 4-8 | 100% | 100% | 97% | 96% |
| #1 | 8-12 | 87 | 98 | 97 | 90 |
| #2 | 4-8 | 68 | 91 | 98 | 86 |
| #2 | 8-12 | 92 | 94 | 98 | 73 |
| #3 | 8-12 | 0 | 0 | 0 | 0 |

### EXPERIMENT 2

In a second set of experiments, granules of composition #1 (mesh size 4-8) were placed into beakers containing 1 liter of water (initial concentration was 30 ng formulation/ml water). 200 Aedes aegypti LII were placed into the beakers and the mortality was determined after 24 hours. Once the mortality was determined, the granules were transferred to “new” beakers, also containing 200 larvae. This process was repeated for 9 days. As seen in the Table below, the effectiveness of the granule did not diminish.

TABLE 3
Results of Experiment 2 - Residual Activity of Granules

| Day of Exposure | Percent of mortality |
|---|---|
| Day 1 | 94% |
| Day 2 | 95 |
| Day 3 | 98 |
| Day 4 | 46 |
| Day 5 | 99 |
| Day 6 | 99 |
| Day 7 | 99 |
| Day 8 | 98 |
| Day 9 | 99 |

### EXPERIMENT 3

400 mosquito larvae each of Aedes aegypti were added to 5-4 liter flasks of autoclaved water. 2 granules (50 mg total weight) of composition #1 (mesh size 8-12) were added to each flask. The mortality of the larvae was tested under the radiation conditions shown in Table 4. Mortality rates are shown after 24, 48, and 96 hours. By itself, Bti is not stable in the sun and thus no larvae are killed. In the granular formation of the present invention, however, direct sun exposure and then bioassay in the shade (#3) or exposure to light in a shaded area (#2) produces high larvae mortality, thus showing that the Bti is stable when in the granular composition. When the bioassay was conducted in the sun (#1), little larvae were killed because the larvae did not feed regularly since they prefer the shade (feeding stimulants could possibly change these results).

TABLE 4
Effect of sun on stability granule

| | 24 hrs | 48 hrs | 96 hrs |
|---|---|---|---|
| 1) Direct sun | 12% | | |
| exposure, | | | |
| Bioassay | | | |
| in sun | | | |
| 2) Exposure to light | 80 | 96 | 89 |
| in shaded area | | | |
| 3) Direct sun | 90 | 94 | 85 |
| exposure, | | | |
| Bioassay | | | |
| in shade | | | |
| 4) Exposure to lab | 66 | | |
| fluorescence light | | | |
| 5) Larvae exposed | <1 | | |
| to sun (control) | | | |

1. A floating sustained release pesticide granule adapted for broadcast application for controlling a population of insects in an aquatic environment, comprising an effective amount of an active ingredient suspended in a water soluble sunscreen agent, and a floatation agent, said active ingredient, sunscreen agent and floatation agent embedded in an insoluble fibrous matrix such that when said granule is in contact with water, said water soluble sunscreen agent dissolves over time thereby releasing the active ingredient into the water in a sustained release manner; wherein the breakdown products of said granule are non-toxic being suitable for human consumption; and further wherein the active ingredient of said granule is released in a sustained manner for a period of approximately the weeks to 30 days.

2. A floating sustained release pesticide granule according to claim 1, wherein the active ingredient comprises a larvicidal protein.

3. A sustained release pesticidal granule according to claim 2, wherein the larvicidal protein comprises the delta endotoxin of Bacillus thuringiensis israelensis.

4. A sustained release pesticidal granule according to claim 2, wherein the larvicidal protein comprises Bacillus spheticus.

5. A sustained release pesticidal granule according to claim 1, wherein said effective amount of active ingredient is between 5-60 wt %.

6. A sustained release pesticidal granule according to claim 5, wherein said effective amount of active ingredient is between 15-20 wt %.

7. A sustained release pesticidal granule according to claim 1, wherein the water soluble sunscreen agent comprises a naturally occurring pigment.

8. A sustained release pesticidal granule according to claim 7, wherein the pigment comprises humate.

9. A sustained release pesticidal granule according to claim 8, wherein the humate is at a concentration of 1-25 wt %.

10. A sustained release pesticidal granule according to claim 1, wherein the floation agent is derived from at least one of the group consisting of: perlites, vermiculites, feather powder, peanut shells, and cellulose byproducts.

11. A sustained release pesticidal granule according to claim 1, wherein the floatation agent comprises perlite treated with a hydrophobic material.

12. A sustained release pesticidal granule according to claim 1, wherein the floatation agent comprises vermiculite beads treated with a hydrophobic material.

13. A sustained release pesticidal granule according to claim 11 or 12, wherein the hydrophobic material comprises molten wax.

14. A sustained release pesticidal granule according to claim 11 or 12, wherein the hydrophobic material comprises hydrophobic silica.

15. A sustained release pesticidal granule according to claim 1, wherein the floatation agent is at a concentration of 5-60 wt. %.

16. A sustained release pesticidal granule according to claim 1, wherein the fibrous matrix is derived from sludge and treated with hydrophobic material.

17. A sustained release pesticidal granule according to claim 1, further comprising a surfactant.

18. A sustained release pesticidal granule according to claim 17, wherein the surfactant is selected from anionic or neutral surface-active agents.

19. A sustained release pesticidal granule according to claim 18, wherein the surface-active agent is alkyl polyglucoside or alkyl aryl sulfonate.

20. A sustained release pesticidal granule according to claim 18, wherein the surface-active agent is at a concentration of 0.001-0.5 wt %.

21. A sustained release pesticidal granule according to claim 19, wherein the concentration is 0.005-0.1 wt %.

22. A sustained release pesticidal granule according to claim 1, further comprising an inert filling material.

23. A sustained release pesticidal granule according to claim 22, wherein the filling material comprises at least one of a calcium carbonate or a silicate.

24. A sustained release pesticidal granule according to claim 22, wherein the filing material is present at a concentration of 1-25 wt %.

25. A sustained release pesticidal granule according to claim 1, further comprising a feeding stimulant.

26. A sustained release pesticidal granule according to claim 25, wherein the feeding stimulant is selected from at least one of the group consisting of: fish meal, soy meal, cotton seed meal, and yeast meal or extracts.

27. A sustained release pesticidal granule according to claim 25, wherein the feeding stimulant is at a concentration of 0.1-10.0 wt %.

28. A method for controlling a population of insects comprising applying by broadcast means a sustained release pesticide granular composition comprising 5-60% of a larvicidal protein, 5-60% floating hollow particles coated with hydrophobic material, 1-25% water soluble sunscreen pigment, and 1-25% of insoluble fibrous matrix.

29. A method according to claim 28, wherein the granular composition further comprises 1-25% of inert filling material.

30. A method according to claim 29, wherein the inert filling material is selected from the group consisting of calcium carbonate or silicates.

31. A method according to claim 28, wherein the granular composition further comprises 0.1-10% larvae feeding stimulants.

32. A method according to claim 31, wherein the larvae feeding stimulants are selected from the group consisting of fish meal, soy meal, cotton seed meal, and yeast meal.

33. A method according to claim 28, wherein the granular composition further comprises 0.1-5% of natural detergents.

34. A method according to claim 33, wherein the natural detergent is selected from the group consisting of alkyl polysaccharides or Tweens.

35. A method according to claim 28, wherein the larvicidal protein comprises the delta endotoxin of Bacillus thuringiensis israelensis.

36. A method according to claim 28, wherein the water soluble sunscreen pigment comprises humate.

37. A method according to claim 28, wherein the floating hollow particles are selected from the group consisting of: perlites, vermiculites, feather powder, peanut shells, corn cob, and cork byproducts.

38. A method according to claim 28, wherein the hydrophobic material comprises molten wax or hydrophobic silica or natural oil or fat.

39. A method according to claim 28, wherein the insoluble fibrous matrix is derived from sludge.

40. A method for producing a sustained release pesticide granule comprising;
(One) mixing an active pesticide ingredient with a water soluble sunscreen agent to create a slurry;
(Two) adding a predetermined amount of floating hollow particle coated with a hydrophobic material to said slurry and mixing until a substantially homogenous mixture is formed;
(Three) blending pre-treated industrial sludge with said mixture until a wet granule composite appears;
(Four) rolling the resulting composite to achieve the desired range of granule sizes;
(Five) optionally, drying the granules until residual water amount reaches a desired level.

41. A method according to claim 40, further comprising adding at least one of the group consisting of: surfactants, inert filling materials, feeding stimulants, natural detergents, and buffers.

42. A method according to claim 40, further comprising applying further amounts of said hydrophobic material.

43. A method according to claim 40, wherein the active ingredient is a larvicidal protein.

44. A method according to claim 40, wherein the larvicidal protein is the delta endotoxin of Bacillus thuringiensis israelensis.

45. A method according to claim 40, wherein the water soluble sunscreen agent comprises humate.

46. A method according to claim 40, wherein the floating hollow particles are selected from the group consisting of: perlites, vermiculites, feather powder, peanut shells, corn cob, and cellulose byproducts.

47. A method according to claim 40, wherein the hydrophobic material comprises molten wax or hydrophobic silica or natural oil or fat.
